(19) United States
(12) Patent Application Publication
(10) Pub. No.: US 2005/0126324 A1
(43) Pub. Date: Jun. 16, 2005

(54) Reflow device of ball screw

(76) Inventors: Paul Yang, Taichung Hsien (TW); Chien-Wei Tsou, Da Li City (TW)

Correspondence Address: CHARLES E. BAXLEY, ESQ., 90 JOHN STREET, THIRD FLOOR, NEW YORK, NY, 10038, US

(21) Appl. No.: 10/734,540

(22) Filed: Dec. 12, 2003

(51) Int. Cl. F16H 25/22

(52) U.S. Cl. 74/424.86

(57) ABSTRACT

The present invention relates to a reflow device of ball screw. The main characteristic of the reflow device is a combinative structure that is made up of the hard material and the soft material. And the soft material surround the balls when they are entered the reflow device, therefore can reduce the noise the balls bring on.

### BACKGROUND OF THE INVENTION

1. Field of the Invention

The present invention relates to a reflow device for ball screw, and more particularly to a reflow device which is capable of improving the noise and vibration reduction during the operation of the ball screw.

2. Description of the Prior Arts

Sound is caused by vibration of an object. Via the medium (such as gas, liquid or solid) vibration is able to transmit energy, and thus forms sound wave, all the sounds that can cause people's mental or physical unpleasing feeling are noises.

The ball screw commonly applied in industrial circles generally includes shaft, screw nut assembly and rolling balls. The screw nut assembly is mounted on the shaft, whereas the rolling balls are disposed between the screw nut assembly and the shaft, such that the roll of the rolling balls produces relative movement between the shaft and the screw nut assembly. To enable the rolling balls to roll cyclically, it should be provided with a reflow device serving to turn the moving direction of the rolling balls. However, the reflow device is right the noise source of the ball screw.

A conventional ball screw is shown in FIG. 5, wherein screw nut assembly 20 is movably mounted on shaft (not shown), rolling balls 40 are disposed between the screw nut assembly 20 and the shaft, for enabling the rolling balls 40 to roll cyclically, it should be provided with a reflow device 30 serving to turn the moving direction of the rolling balls 40. The noise problem of the conventional ball screw is generally caused by the two reasons as flows: first is because the reflow device 30 is normally made of a single material. Second is in consideration of the integral strength and assembly of the reflow device 30, it is usually made of metal or other hard materials. In operation, when the reflow device 30 is collided by the rolling balls 40, due to the reflow device 30 is too hard, the caused noise and vibration is accordingly bigger.

The present invention has arisen to mitigate and/or obviate the afore-described disadvantages of the conventional reflow device for ball screw.

### SUMMARY OF THE INVENTION

The primary object of the present invention is to provide a reflow device for ball screw which is able to reduce noise and vibration caused by the collision of rolling balls. To reduce the noise, it should start with the noise resource, the noise transmission and the sound-receiving surround. The noise problem can be permanently solved if the noise resource is reduced. Wherein by reducing the vibration of the noise resource can reduce the noise.

First of all, according to the kinetics of particles, when two objects collide with each other, the lower the coefficient of restitution “e” (general object is partial elastic member, 0<e<1), the greater the mechanical energy loss, therefore, the kinetic energy after collision will be reduced and the vibration of the objects will be reduced accordingly, so as to reduce the noise. The present invention is designed to improve the noise reduction by reducing the vibration of the noise-resource, thereby which uses materials with lower coefficient of restitution to collide with the rolling balls. Normally, soft material has lower coefficient of restitution than that of hard material. In this case, the reflow device in accordance with the present invention is designed as being a combinative structure made of hard material and soft material. Wherein turning portion of rolling path for turning moving direction of the rolling balls is covered with low coefficient of restitution material, Whereas the rest portion of the reflow device of the present invention is made of hard material. The hard material makes the rolling path strength enough to bear the high-speed moving rolling balls. When the rolling balls run through the reflow device and collide with the turning path, the kinetic energy of which will be substantially buffered and absorbed by the soft material. As a result, the kinetic energy reduction will cause vibration reduction, and so as to improve the noise reduction.

In addition, as shown in FIG. 4, which is a noise comparison diagram of illustrating the noises caused by striking of the rolling balls with collision portions made of different materials. Wherein material “A” is made of polyacetal material (which is the material commonly used in conventional reflow device), whereas material “B” is made of thermoplastic elastic material (the hardness is 35D-63D, tensile stress 10.3-41 MPa, Flexural modulus at normal atmospheric temperature 30 MPa-330 MPa). The diagram illustrates the noises caused by striking of the rolling balls with reflow device at different rotational speed. As can be seen in the diagram, the higher the rotational speed, the louder the noises caused by striking of material “A” and “B” with the reflow device. Sound is air pressure variation that can be received by ear. dB is used to measure sound level, the dB is defined as: dB=10 log (P/Po). Wherein “P” means actual sound pressure, “Po” is internationally acknowledged reference sound pressure. As can be seen from the above equation, the addition of sound is not arithmetic sum but sum of log. For example, when the sound pressure is doubled (P is doubled) the sound volume will be 3 dB louder, when the sound pressure is ten-fold higher, the sound volume will be 10 dB louder. As shown in FIG. 4, when the rolling balls are running at 2500 rpm, the noise caused by the thermoplastic elastic material is 3-4 dB lower than the noise caused by the polyacetal material. In other words, the sound pressure caused by the thermoplastic elastic material is half of the sound pressure caused by the polyacetal material. In this case, thermoplastic elastic material can be applied to covering the rolling path of the reflow device of the present invention, such that the vibration and noise reduction of it is hopefully much improved.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a partial perspective view of a reflow device for ball screw in accordance with an embodiment of the present invention;

FIG. 2 is an illustrative view of showing the reflow device of FIG. 1 being collided by rolling balls;

FIG. 3 is a cross sectional view taken along C-C of FIG. 2;

FIG. 4 is a noise comparison diagram of illustrating the noises caused by striking of the rolling balls with collision portions made of different materials;

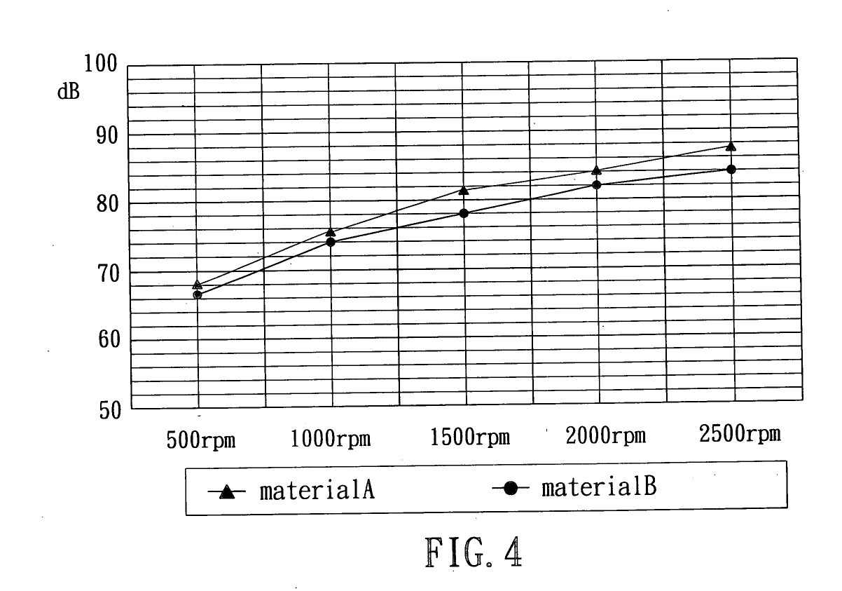

FIG. 5 is a cross sectional assembly view of a conventional ball screw.

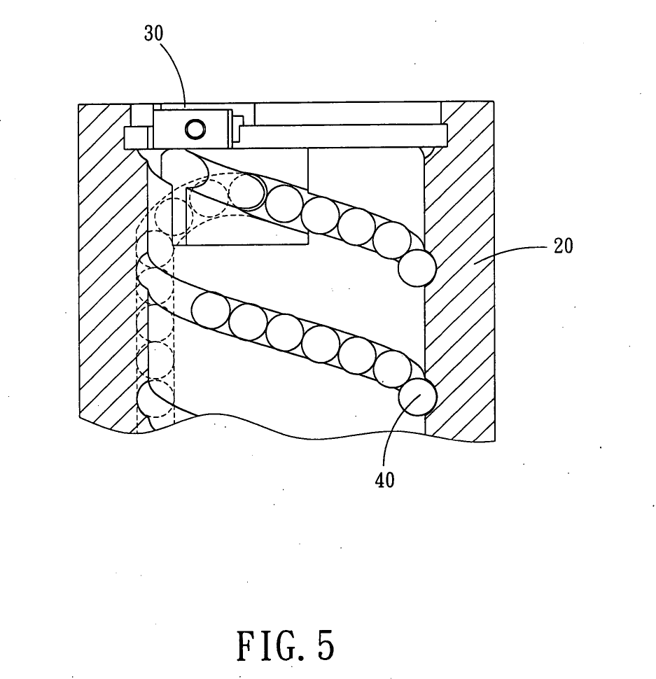

### DETAILED DESCRIPTION OF THE PREFERRED EMBODIMENTS

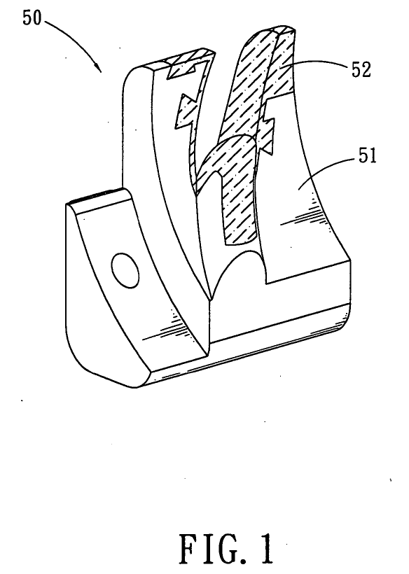

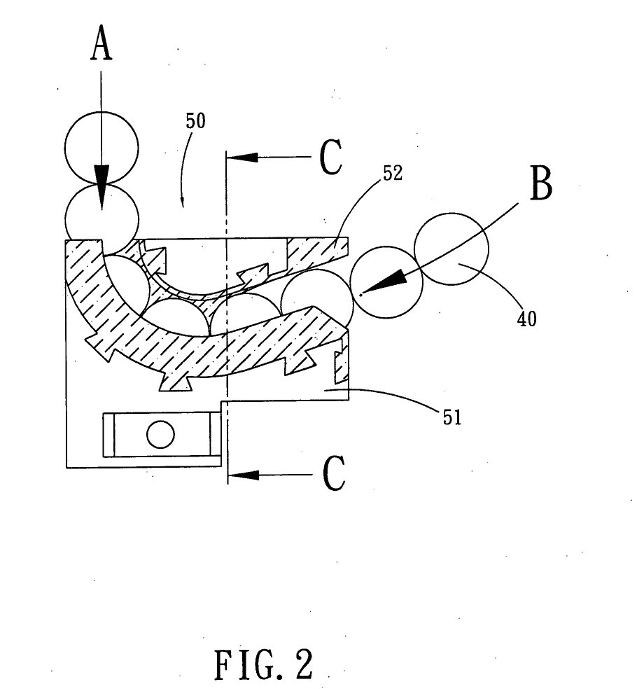

FIG. 1 is a partial perspective view of a reflow device for ball screw in accordance with an embodiment of the present invention. FIG. 2 is an illustrative view of showing the reflow device of FIG. 1 being collided by rolling balls. Here takes a reflow device equipped with end cup as an example, wherein the reflow device 50 is comprised of hard portion 51 and soft portion 52. Rolling balls 40 rolling in the reflow device 50 is surrounded by soft portion 52, the hard portion 51 covers the outside of the soft portion 52, so as to increase the strength of the reflow device 50. This structure ensures that the rolling balls 40, whatever entering the reflow device 50 from “A” side or “B” side, will collide with the soft portion 52. The collision of the rolling balls 40 can be substantially buffered and absorbed by the soft portion 52, such that the caused vibration and noise is effectively reduced.

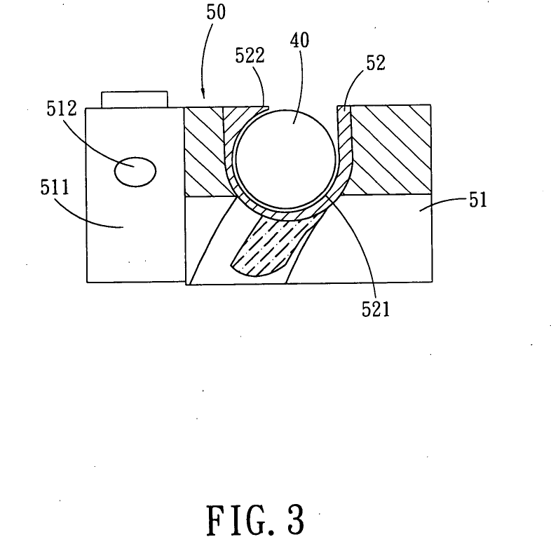

FIG. 3 is a cross sectional view taken along C-C of FIG. 2. Wherein recirculating path 521 is defined in the soft portion 52, which has an external diameter slightly greater than that of the rolling balls 40. The recirculating path 521 is used to turn the moving direction of the rolling balls 40, in the soft portion 52 is further provided with an extending edge 522 connecting to the recirculating path 521, so as to confine the rolling balls 40 in the recirculating path 521. On the other hand, the hard portion 51 covering the outside of the soft portion 52 enables the reflow device 50 to be strengthen enough. The hard portion 51 is provided with a fixed block 511, on which is further defined with a locking hole 512 for enabling the reflow device 50 to be integrally fixed to screw nut assembly (not shown), so as to allow the rolling balls 40 to circulate along the rolling path.

While we have shown and described various embodiments in accordance with the present invention, it should be clear to those skilled in the art that further embodiments may be made without departing from the scope of the present invention.

1. A reflow device for ball screw, in which provided with recirculating path, the recirculating path serving to turn moving direction of rolling balls, the reflow device can be fixed to screw nut assembly and integrally combined with screw nut, so as to allow the rolling balls to roll cyclically;
the reflow device including hard portion and soft portion, rolling balls entering the reflow device will be surrounded by the soft portion, the hard portion combine with the soft portion, so as to increase the strength of the reflow device, the collision of the rolling balls can be substantially buffered and absorbed by the soft portion, such that the caused vibration and noise can be effectively reduced.

2. The reflow device for ball screw as claimed in claim 1, wherein in the soft portion of the reflow device is provided with extending edge connecting to the recirculating path, so as to confine rolling balls moving in the recirculating path.

3. The reflow device for ball screw as claimed in claim 1, wherein the soft portion of the reflow device can be made of thermoplastic elastic material, such that the vibration and noise reduction of the reflow device can be substantially improved.

4. The reflow device for ball screw as claimed in claim 1, wherein the hardness of the material of the soft portion is 35D-63D.

5. The reflow device for ball screw as claimed in claim 1, wherein the tensile stress of the material of the soft portion is 10.33 MPa-41 MPa.

6. The reflow device for ball screw as claimed in claim 1, wherein the Flexural modulus of the soft portion at normal atmospheric temperature is 30 MPa-330 MPa.

7. The reflow device for ball screw as claimed in claim 1, wherein the hard portion of the reflow device is made of metal.

8. The reflow device for ball screw as claimed in claim 1, wherein the hard portion of the reflow device is made of polyacetal material.
